(19) United States
(12) Patent Application Publication
(10) Pub. No.: US 2026/0131745 A1
(43) Pub. Date: May 14, 2026

(54) SETTING DEVICE AND ON-VEHICLE APPARATUS

(71) Applicants: TOYOTA JIDOSHA KABUSHIKI KAISHA, Toyota-shi, Aichi-ken (JP); SUMITOMO ELECTRIC INDUSTRIES, LTD., Osaka-shi (JP); AUTONETWORKS TECHNOLOGIES, LTD., Yokkaichi-shi (JP); SUMITOMO WIRING SYSTEMS, LTD., Yokkaichi-shi (JP)

(72) Inventors: Yasuhiro YAMASAKI, Nisshin-shi (JP); Hideki GOTO, Okazaki-shi (JP); Ikuyoshi OTAKE, Toyota-shi (JP); Yusuke YAMAMOTO, Osaka-shi (JP); Ryo YAMANE, Osaka-shi (JP); Kenta OGATA, Osaka-shi (JP); Tatsuya IZUMI, Osaka-shi (JP); Hideyuki TANAKA, Osaka-shi (JP); Yoshitaka KIKUCHI, Yokkaichi-shi (JP); Hirofumi URAYAMA, Yokkaichi-shi (JP); Darmawan GO, Yokkaichi-shi (JP)

(73) Assignees: TOYOTA JIDOSHA KABUSHIKI KAISHA, Toyota-shi, Aichi-ken (JP); SUMITOMO ELECTRIC INDUSTRIES, LTD., Osaka-shi (JP); AUTONETWORKS TECHNOLOGIES, LTD., Yokkaichi-shi (JP); SUMITOMO WIRING SYSTEMS, LTD., Yokkaichi-shi (JP)

(21) Appl. No.: 19/119,341

(22) PCT Filed: Oct. 5, 2023
(86) PCT No.: PCT/JP2023/036311

§ 371 Date: Apr. 8, 2025

(30) Foreign Application Priority Data
Nov. 1, 2022 (JP) 2022-175500

(51) Int. Cl. B60R 16/023; H04L 45/42

(52) U.S. Cl. CPC B60R 16/023; H04L 45/42

(57) ABSTRACT

An SDN controller controls communication settings of SDN switches of a vehicle on-board network. The SDN controller includes a memory that stores multiple types of configuration information to which unique identifiers are respectively assigned. The SDN controller executes an acquisition process, a selecting process, and an updating process when a new vehicle on-board device is connected to the vehicle on-board network. The acquisition process is a process that acquires, from outside, an identifier corresponding to the vehicle on-board device to be newly connected. The selecting process is a process that selects the configuration information corresponding to the identifier acquired in the acquisition process from the multiple types of configuration information stored in the memory. The updating process is a process that updates the communication settings of the SDN switch based on the configuration information selected in the selecting process.

### CROSS-REFERENCE TO RELATED APPLICATIONS

This application is national stage application of International Application No. PCT/JP2023/036311, filed on Oct. 5, 2023, which designates the United States, and which claims the benefit of priority from Japanese Patent Application No. 2022-175500, filed on Nov. 1, 2022, the entire contents of which is incorporated herein by reference.

### TECHNICAL FIELD

The present disclosure relates to a configuration device that controls the communication settings of a communication device installed in a vehicle on-board network. The present disclosure also relates to a vehicle on-board device that is connected to a vehicle on-board network where the configuration device is installed.

### BACKGROUND ART

Patent Literature 1 discloses a software defined networking (SDN) system that enables modification of the configuration and settings of a network by controlling a communication device with software, without altering the hardware configuration. The SDN system includes SDN switches and an SDN controller that updates the communication settings of each SDN switch, which is a frame relay device.

### CITATION LIST

### Patent Literature

Patent Literature 1: Japanese Laid-Open Patent Publication No. 2017-169044

### SUMMARY OF INVENTION

### Technical Problem

The SDN system as described above may be used in a vehicle on-board network. Meanwhile, in a vehicle, new vehicle on-board devices may be connected to the vehicle on-board network for purposes such as the addition of functions. When connecting a new vehicle on-board device changes the configuration of the vehicle on-board network, it is necessary to update the communication settings of the SDN switches in a suitable manner.

### Solution to Problem

An aspect of the present disclosure provides a configuration device that controls communication settings of multiple communication devices of a vehicle on-board network. The configuration device includes a memory that stores multiple types of configuration information to which unique identifiers are respectively assigned. The configuration device is configured to execute an acquisition process, a selecting process, and an updating process when connecting a vehicle on-board device to the vehicle on-board network. The acquisition process is a process that acquires an identifier corresponding to the vehicle on-board device from outside. The selecting process is a process that selects, from the multiple types of configuration information, configuration information corresponding to the identifier acquired in the acquisition process. The updating process is a process that updates the communication settings of the communication devices based on the configuration information selected in the selecting process.

Another aspect of the present disclosure provides a vehicle on-board device connected to a vehicle on-board network to which communication devices are connected and a configuration device is set. The configuration device includes a memory that stores multiple types of configuration information to which unique identifiers are respectively assigned. The configuration device updates communication settings of the communication devices based on the configuration information. The vehicle on-board device is configured to notify the configuration device of an identifier for configuration information when connecting to the vehicle on-board network. The configuration information is used by the configuration device to update the communication settings.

### BRIEF DESCRIPTION OF DRAWINGS

FIG. 1 is a diagram schematically showing the configuration of a configuration device according to a first embodiment.

FIG. 2 is a sequence diagram illustrating an example of the update operation for the communication settings.

FIG. 3 is a sequence diagram illustrating another example of the update operation for the communication settings.

FIG. 4 is a schematic diagram illustrating the configuration of the OTA master installed in the vehicle on-board network where the configuration device of the second embodiment is provided.

FIG. 5 is a sequence diagram illustrating an example of the update operation for the configuration information and communication settings.

FIG. 6 is a sequence diagram illustrating an example of the update operation for the configuration information and communication settings.

### DESCRIPTION OF EMBODIMENTS

### First Embodiment

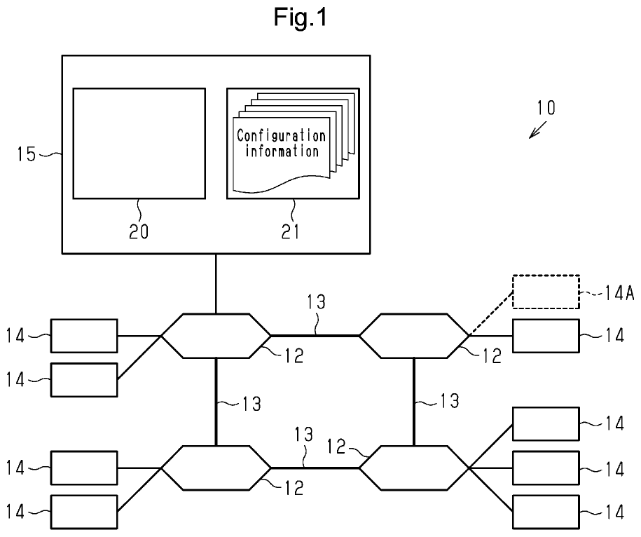

A configuration device according to a first embodiment will now be described in detail with reference to FIGS. 1 to 3.

### Configurations of Vehicle On-Board Network and Configuration Device

First, the configurations of a vehicle on-board network 10 in which the present embodiment is employed and the configuration device of the present embodiment will be described with reference to FIG. 1. As shown in FIG. 1, the vehicle on-board network 10 includes SDN switches 12. The SDN switches 12 are connected to each other via a network link 13. Each SDN switch 12 is connected to vehicle on-board devices 14. Each vehicle on-board device 14 transmits and receives frames via the vehicle on-board network 10 to and from each other. The vehicle on-board device 14 includes various electronic control units (ECUs), sensors, and a car navigation system that are mounted on the vehicle. Each vehicle on-board device 14 includes an interface that transmits and receives frames. In the vehicle on-board network 10, each SDN switch 12 relays frames that are transmitted and received by each vehicle on-board device 14. The SDN switch 12 and the vehicle on-board device 14 are communication devices included in the vehicle on-board network 10.

One of the SDN switches 12 is connected to an SDN controller 15. The SDN controller 15 is a configuration device that controls the communication settings of each SDN switch 12. The communication settings define the rules for frame forwarding, including the communication paths for frames between the vehicle on-board devices 14, restrictions on communication paths for security, and adjustments to transmission order and transmission volume for quality of service (QOS). For example, the communication settings include a routing table that specifies the destination for the transfer of frames for each address.

The SDN controller 15 includes a CPU 20 and a memory 21. The CPU 20 executes the processes related to updating the communication settings. The memory 21 stores, in advance, programs and data used for the processes by the CPU 20.

### Connection of New Vehicle On-Board Device to Vehicle On-Board Network

There may be a case in which a new vehicle on-board device 14 is connected to the vehicle on-board network 10 to add new functions or the like to the vehicle. Connecting the new vehicle on-board device 14 to the vehicle on-board network 10 includes not only installing the new vehicle on-board device 14 in the vehicle but also the following case.

At present, the vehicle on-board device 14 may be preinstalled in a deactivated state in the vehicle to implement a function that is currently prohibited by regulations, in anticipation of future regulatory revisions. The vehicle on-board device 14 in a deactivated state is ignored by the vehicle on-board network 10, even if it is physically connected to the vehicle on-board network 10. When activated, the vehicle on-board device 14 is treated as if being newly connected to the vehicle on-board network 10. In the present embodiment, the connection of a vehicle on-board device 14 activated from a deactivated state is included in the connection of a new vehicle on-board device 14 to the vehicle on-board network 10.

In the following description, the vehicle on-board device 14 that is newly connected to the vehicle on-board network 10 will be referred to as the new vehicle on-board device 14A. The new vehicle on-board device 14A is, for example, an ECU or a sensor. Further, the vehicle on-board network 10 may be connected to a unit including one or more ECUs, one or more sensors, and an SDN switch to which the ECUs and the sensors are connected. For example, a unit that adds the functions for vehicle autonomous driving to a vehicle includes cameras and sensors that recognize objects around the vehicle, an ECU that calculates a travel route and a travel speed of the vehicle, and an SDN switch to which these components are connected. If such a unit is newly connected to the vehicle on-board network 10, that unit can also be a new vehicle on-board device 14A.

The configuration of the vehicle on-board network 10 changes due to the connection of a new vehicle on-board device 14A. In addition, the connection of the new vehicle on-board device 14A alters how frame-based communication is performed within the vehicle on-board network 10. The SDN controller 15 updates the communication settings of each SDN switch 12 when the new vehicle on-board device 14A is connected.

The manner of communication performed by the new vehicle on-board device 14A varies depending on its type. For example, when the new vehicle on-board device 14A is a sensor, the sensor basically performs only frame transmission. Further, depending on the detection target of the sensor, there is limitation to the vehicle on-board device 14 in which the sensor transmits frames. Furthermore, depending on the type of the new vehicle on-board device 14A, the volume and priority of communication executed by the new vehicle on-board device 14A may also differ. For example, when the new vehicle on-board device 14A is a unit that adds the functions for autonomous driving as described above, the volume and priority of the communication executed by this unit increases. Thus, depending on the type of the new vehicle on-board device 14A, the communication settings required for each SDN switch 12 differs. Additionally, new vehicle on-board devices 14A of the same type may include devices with relatively high communication volumes and devices with relatively low communication volumes. Further, new vehicle on-board devices 14A of the same type may each be connected to a different position within the vehicle on-board network 10. As described above, the communication settings of each SDN switch 12 that correspond to the connection of the new vehicle on-board device 14A vary based on the type, transmission volume, and connection position of the new vehicle on-board device 14A.

The memory 21 of the SDN controller 15 stores multiple types of configuration information in advance. Configuration information indicates the communication settings of each SDN switch 12 that are updated when the new vehicle on-board device 14A is connected. The multiple types of configuration information stored in the memory 21 are each assigned a unique identifier (ID). An identifier is a string or number used to identify specific configuration information.

### Update to Communication Settings

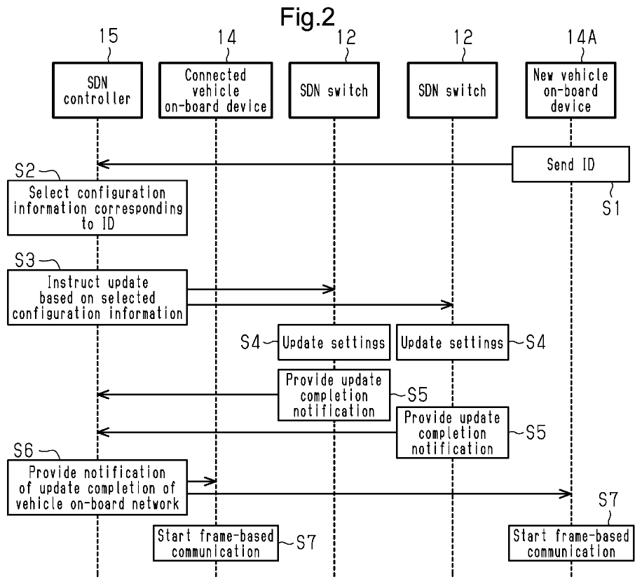

The update to the communication settings in the vehicle on-board network 10 associated with the connection of the new vehicle on-board device 14A will now be described with reference to FIG. 2.

FIG. 2 illustrates an example of the operation of each device related to the update to the communication settings of the vehicle on-board network 10. FIG. 2 illustrates the operation performed after a new vehicle on-board device 14A is physically connected to one of the SDN switches 12 installed in the vehicle on-board network 10 and the connection between the SDN switch 12 and the new vehicle on-board device 14A is established. FIG. 2 illustrates two of the SDN switches 12 installed in the vehicle on-board network 10 and one of the vehicle on-board devices 14 already connected to the vehicle on-board network 10.

Upon being connected to the vehicle on-board network 10, the new vehicle on-board device 14A transmits, to the SDN controller 15, the identifier for the configuration information used to update the communication settings that are applied after the connection (S1). The identifier to be transmitted in this step is stored in the new vehicle on-board device 14A in advance.

From the multiple types of configuration information stored in the memory 21, the SDN controller 15 selects the configuration information that corresponds to the identifier received from the new vehicle on-board device 14A (S2). Based on the selected configuration information, the SDN controller 15 instructs each SDN switch 12 to update the communication settings (S3). Based on the instruction, each SDN switch 12 updates the communication settings (S4). Upon completing the update to the communication settings, each SDN switch 12 notifies the SDN controller 15 of the completion (S5). Upon receiving notifications of update completion from all the SDN switches 12, the SDN controller 15 notifies each connected vehicle on-board device 14 and the new vehicle on-board device 14A that the update to the communication settings of the entire vehicle on-board network 10 is completed (S6). Upon the notification, each connected vehicle on-board device 14 initiates frame-based communication (S7). Further, the new vehicle on-board device 14A is activated in response to the notification, initiating frame-based communication (S7).

After the shipment of vehicles, new models of the vehicle on-board device 14 that can connect to the vehicle on-board network 10 may be added. In such cases, the configuration information corresponding to the added vehicle on-board device 14 may not be stored in the memory 21 of the SDN controller 15. In such cases, the vehicle on-board device 14 to be added is designed to store, in advance, configuration information used for updating the communication settings that correspond to a case in which the vehicle on-board device 14 has been connected to the vehicle on-board network 10. When the vehicle on-board device 14 is connected, the communication settings are updated based on the stored configuration information.

FIG. 3 illustrates an example of the operation of each device related to the update to the communication settings of such cases. In the same manner as described above, upon being connected to the vehicle on-board network 10, the new vehicle on-board device 14A notifies the SDN controller 15 of the identifier stored in advance (S10). In this case, while attempting to select configuration information that matches the identifier, the SDN controller 15 does not have such configuration information. When confirming that the configuration information corresponding to the reported identifier is not stored (S11), the SDN controller 15 requests that the new vehicle on-board device 14A transmit the configuration information stored in the new vehicle on-board device 14A (S12). When the new vehicle on-board device 14A transmits configuration information in response to this request (S13), the SDN controller 15 instructs each SDN switch 12 to update the communication settings based on the configuration information received from the new vehicle on-board device 14A (S14). The subsequent operations are the same as those in FIG. 2.

### Operational Advantages of Embodiment

The operational advantages of the present embodiment will now be described.

The SDN controller 15 includes the memory 21. The memory 21 stores multiple types of configuration information to which unique identifiers are respectively assigned. Each type of configuration information includes information related to not only the settings of the frame transfer path but also quality-of-service settings in frame transfer and the settings of communication path restrictions for security.

Upon being connected to the vehicle on-board network 10, the new vehicle on-board device 14A transfers the identifier stored in advance to the SDN controller 15. From the multiple types of configuration information stored in the memory 21, the SDN controller 15 selects the configuration information that corresponds to the identifier received from the new vehicle on-board device 14A. Based on the selected configuration information, the SDN controller 15 updates the communication settings of each SDN switch 12. As a result, the settings of the frame transfer path, quality of service, and communication path restrictions of each SDN switch 12 are updated. After confirming that the update to the communication settings of all the SDN switches 12 is completed, the SDN controller 15 notifies each vehicle on-board device 14 connected to the vehicle on-board network 10 and the new vehicle on-board device 14A that the update is completed. Upon receiving this notification, each vehicle on-board device 14 and the new vehicle on-board device 14A initiate a frame-based communication.

The configuration information that corresponds to the identifier reported from the new vehicle on-board device 14A may not be stored in the memory 21. That is, multiples types of configuration information stored in the memory 21 may not include the configuration information that should be selected. In this case, the SDN controller 15 updates the communication settings of each SDN switch 12 based on the configuration information stored in the new vehicle on-board device 14A.

In the present embodiment, the SDN switch 12 and the vehicle on-board device 14 correspond to the communication device, the SDN controller 15 corresponds to the configuration device, and the memory 21 corresponds to the memory. The process of S1 of FIG. 2 corresponds to the acquisition process. The process of S2 corresponds to the selecting process. The process of S3 corresponds to the updating process.

The present embodiment described above has the following advantages.

(1) The SDN controller 15 includes the memory 21. The memory 21 stores multiple types of configuration information to which unique identifiers are respectively assigned. The SDN controller 15 executes the acquisition process (S1), the selecting process (S2), and the updating process (S3) when a new vehicle on-board device 14A is connected to the vehicle on-board network 10. The acquisition process is a process that acquires, from the new vehicle on-board device 14A, the identifier corresponding to the new vehicle on-board device 14A. The selecting process is a process that selects, from multiple types of configuration information stored in the memory 21, the configuration information corresponding to the identifier acquired in the acquisition process. The updating process is a process that updates the communication settings of the SDN switch 12 based on the configuration information selected in the selecting process. Specifically, the new vehicle on-board device 14A connected to the vehicle on-board network 10 specifies the configuration information used to update the communication settings. In other words, the communication settings of each SDN switch 12 are updated based on the configuration information corresponding to the identifier acquired from the outside. Thus, even if the SDN controller 15 does not recognize which type of communication is performed by the SDN switch 12 or whether it is connected to the vehicle on-board network 10, the communication settings of the vehicle on-board network 10 are properly updated in response to the connection of the new vehicle on-board device 14.

(2) Each type of configuration information stored in the memory 21 includes the information on quality-of-service settings for frame-based communication and the information on communication path restriction settings for security. This allows advanced communication control, such as the settings of the quality of service for frame transfer and the settings of communication path restriction for security, to be executed in response to changes in the configuration of the vehicle on-board network 10 due to the connection of the new vehicle on-board device 14A.

(3) Due to a discrepancy in the release schedules of the vehicle and the new vehicle on-board device 14A, the setting information stored in the memory 21 may not include the configuration information corresponding to the new vehicle on-board device 14A. In such a case, the SDN controller 15 obtains the configuration information stored in the new vehicle on-board device 14A, and updates the communication settings of each SDN switch 12 based on the configuration information. Thus, even if the configuration information corresponding to the new vehicle on-board device 14A is not stored in the memory 21, the communication settings of each SDN switch 12 corresponding to the new vehicle on-board device 14A are updated.

### Second Embodiment

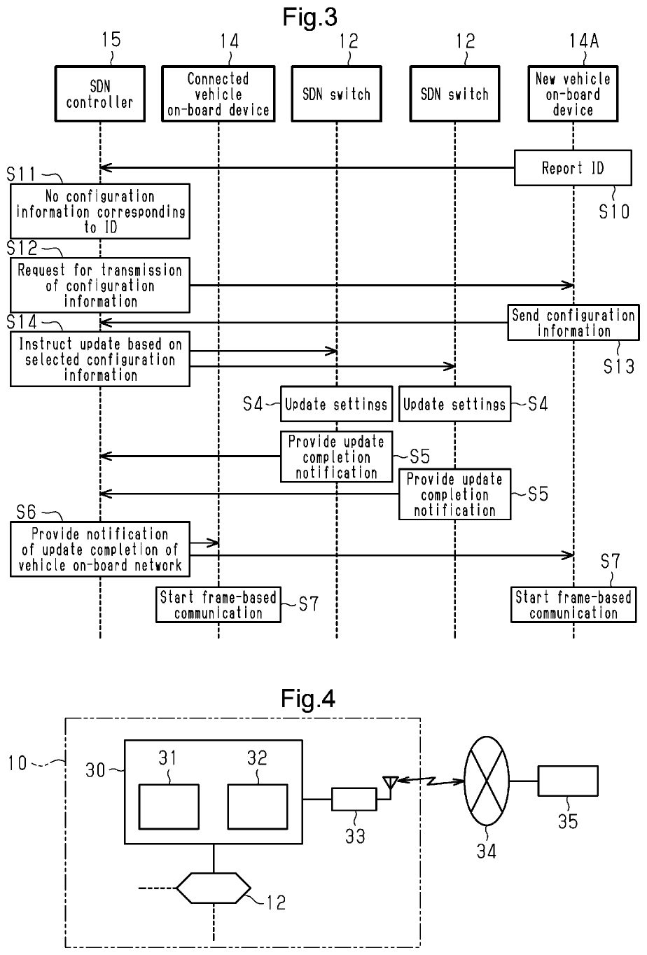

The configuration device according to a second embodiment of the present disclosure will now be described with reference to FIGS. 4 to 6. In the present embodiment, the same reference numerals are given to those components that are the same as the corresponding components of the above-described embodiment. Such components will not be described in detail.

### Configuration of Configuration Device in Second Embodiment

The configuration of the SDN controller 15 in the present embodiment is the same as that of the first embodiment. The SDN controller 15 of the present embodiment updates communication settings in the same manner as the first embodiment. In the vehicle on-board network 10 where the SDN controller 15 of the present embodiment is installed, an OTA master 30 is installed in addition to the SDN switch 12 and the vehicle on-board devices 14. The OTA master 30 serves as a management device that manages a software update to the vehicle on-board devices 14.

As shown in FIG. 4, the OTA master 30 is connected to one of the SDN switches 12 configured in the vehicle on-board network 10. The OTA master 30 is an electronic control unit including a CPU 31 and a memory 32. The CPU 31 executes a process that updates the software of the vehicle on-board device 14. The memory 32 stores programs and data used for processing by the CPU 31. A wireless communication device 33 is connected to the OTA master 30. The wireless communication device 33 establishes data communication with an external data center 35 via a wireless communication network 34, such as a mobile communication network. The data center 35 distributes software update data for the vehicle on-board device 14 to the OTA master 30 of each vehicle via the wireless communication network 34. The OTA master 30 updates the software of the vehicle on-board device 14, which is subject to update, based on the update data distributed from the data center 35. The vehicle on-board device 14 is temporarily disconnected from the vehicle on-board network 10 during the software update. After the software update is completed, the vehicle on-board device 14 is reconnected to the vehicle on-board network 10. Additionally, the data center 35 distributes the update data for configuration information stored in the memory 21 of the SDN controller 15. The OTA master 30 also manages the update to configuration information.

The vehicle on-board device 14 may have its functions altered through a software update. Further, a change in the functions may alter how communication is executed by the vehicle on-board device 14. In the present embodiment, the SDN controller 15 updates the communication settings of each SDN switch 12 during the reconnection of vehicle on-board devices 14 following the software update.

### Update to Configuration Information and Communication Settings

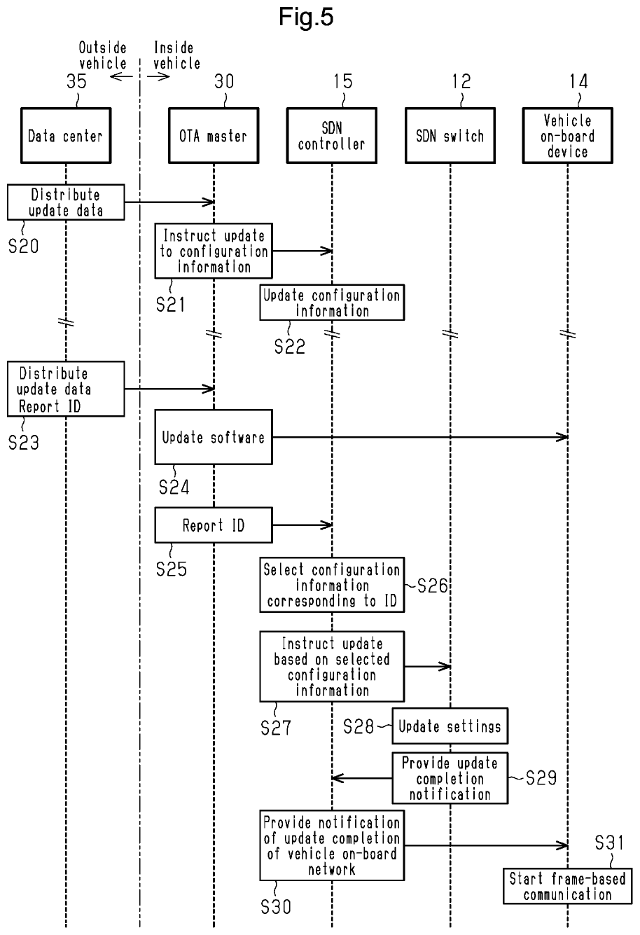

The update to the configuration information and communication settings in the present embodiment will now be described with reference to FIG. 5. FIG. 5 illustrates the operations of the data center 35, the OTA master 30, the SDN controller 15, and the SDN switch 12, all of which are related to the updating of configuration information and communication settings. FIG. 5 illustrates one of the SDN switches 12 installed in the vehicle on-board network 10.

In FIG. 5, the data center 35 distributes update data for configuration information prior to distributing software update data for the vehicle on-board device 14 (S20). Upon receiving the update data from the data center 35, the OTA master 30 transmits the update data to the SDN controller 15 (S21). The SDN controller 15 updates the configuration information stored in the memory 21 based on the update data (S22). The configuration information updated in this step includes configuration information indicating the communication settings of each SDN controller 15 that corresponds to the software update to the vehicle on-board device 14. The configuration information is updated not only during software update but also, for example, when a new model of the vehicle on-board device 14 connectable to the vehicle on-board network 10 is added.

Subsequently, the data center 35 distributes the software update data of the vehicle on-board device 14 (S23). Additionally, the data center 35 notifies the OTA master 30 of the identifier for the configuration information used to update the communication settings that are applied after the software update (S23). Upon receiving the update data from the data center 35, the OTA master 30 updates the software of the vehicle on-board device 14 that is subject to update based on the update data (S24). Upon completing the software update, the OTA master 30 notifies the SDN controller 15 that the software update is completed (S25). Additionally, the OTA master 30 notifies the SDN controller 15 of the identifier reported by the data center 35 (S25).

From the multiple types of configuration information stored in the memory 21, the SDN controller 15 selects the configuration information that corresponds to the identifier reported from the OTA master 30 (S26). Based on the selected configuration information, the SDN controller 15 instructs each SDN switch 12 to update the communication settings (S27).

Each SDN switch 12 updates the communication settings based on the instruction (S28). Upon completing the update to the communication settings, each SDN switch 12 notifies the SDN controller 15 of the completion (S29). Upon receiving update completion notifications from all the SDN switches 12, the SDN controller 15 notifies the connected vehicle on-board device 14 that has undergone the software update that the update to the communication settings of the entire vehicle on-board network 10 is completed (S30). The vehicle on-board device 14 is activated in response to this notification, and begins frame-based communication (S31).

Updates to the configuration information and software may each require the permission of a user. If the user permits the software update before permitting the update to the configuration information, the software update will be executed prior to the update to the configuration information. In such a case, the configuration information stored in the memory 21 may not include configuration information that matches the updated software.

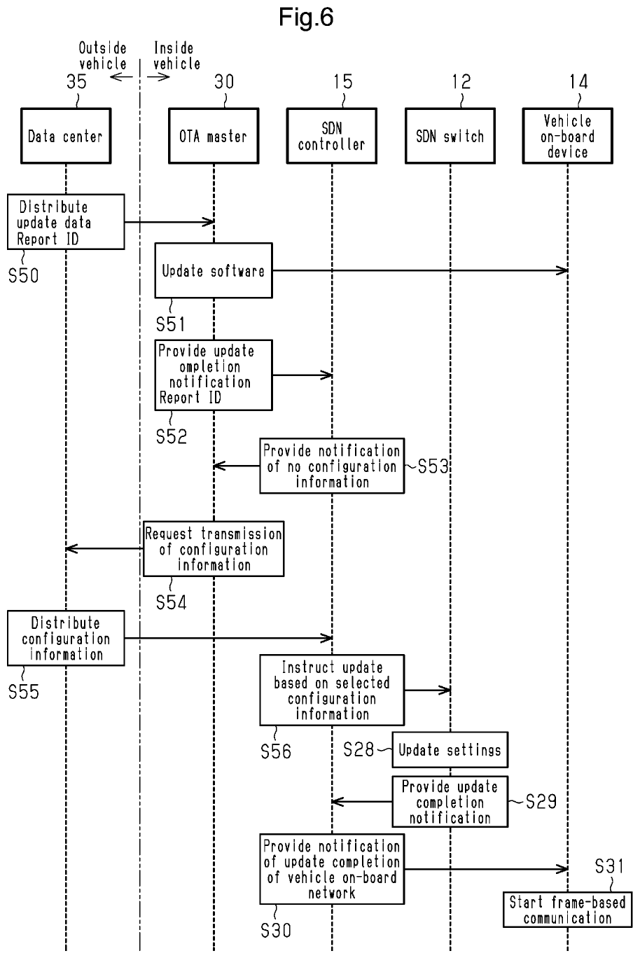

FIG. 6 illustrates the operations of the data center 35, the OTA master 30, the SDN controller 15, and the SDN switch 12, all of which are related to the updating of communication settings in such a case.

In this case, the data center 35 first distributes software update data of the vehicle on-board device 14 (S50). Then, the OTA master 30 updates the software of the vehicle on-board device 14 that is subject to update based on the update data (S51). Upon completing the software update, the OTA master 30 notifies the SDN controller 15 that the software update is completed (S52). In this step, the OTA master 30 notifies the SDN controller 15 of the identifier, which was reported from the data center 35 during distribution of updated data (S52). However, in this case, multiple types of configuration information stored in the memory 21 do not include configuration information corresponding to the identifier. In this case, the SDN controller 15 notifies the OTA master 30 that the corresponding configuration information is not stored in the memory 21 (S53). Upon receiving this notification, the OTA master 30 requests that the data center 35 distribute configuration information corresponding to the previously implemented software update (S54). The configuration information distributed by the data center 35 in response to this request is transmitted to the SDN controller 15 via the OTA master 30 (S55). Then, the SDN controller 15 instructs each SDN switch 12 to update the communication settings based on the received configuration information (S56). The subsequent operations are the same as those in FIG. 5.

### Operational Advantages of Embodiment

The operational advantages of the present embodiment will now be described.

The OTA master 30 updates the software of the vehicle on-board device 14, based on the update data distributed from the data center 35. Based on the update data distributed from the data center 35, the OTA master 30 updates the configuration information stored in the memory 21 of the SDN controller 15.

Upon completing the software update to the vehicle on-board device 14, the OTA master 30 transmits the information on the type, communication volume, and connection position of the vehicle on-board device 14 to the SDN controller 15. As a result, the SDN controller 15 obtains, from the OTA master 30, the information on the type, communication volume, and connection position used to select configuration information. Based on that information, the SDN controller 15 then selects one of multiple types of configuration information stored in the memory 21. Based on the selected configuration information, the SDN controller 15 updates the communication settings of each SDN switch 12.

Multiple types of configuration information stored in the memory 21 may not include configuration information corresponding to the identifier reported from the OTA master 30. In this case, the SDN controller 15 obtains configuration information used to update the communication settings of the SDN switch 12 from the external data center 35.

In the present embodiment, the OTA master 30 corresponds to the management device, which manages a software update to the vehicle on-board devices 14 connected to the vehicle on-board network 10. The process of S25 in FIG. 5 corresponds to the acquisition process. The process of S26 corresponds to the selecting process. The process of S27 corresponds to the updating process.

The present embodiment described above has the following advantages in addition to the above-described advantages (1) to (3).

(4) In the vehicle on-board network 10 where the SDN controller 15 of the present embodiment is installed, the OTA master 30 is installed to manage a software update to the vehicle on-board devices 14. The software update may alter the functions of the vehicle on-board device 14, which can necessitate updating the communication settings of the vehicle on-board network 10. Thus, the OTA master 30 issues a notification to the SDN controller 15 when the software update to the vehicle on-board device 14 is completed. In response to receiving the notification, the SDN controller 15 executes the acquisition process (S25), the selecting process (S26), and the updating process (S27), and updates the communication settings of each SDN switch 12. That is, the SDN controller 15 updates the communication settings of each SDN switch 12 upon the completion of the software update to the vehicle on-board device 14. This allows for updating of the communication settings of the vehicle on-board network 10 that correspond to software updates for the vehicle on-board device 14.

(5) From the OTA master 30, the SDN controller 15 acquires the identifier for the configuration information selected in the selecting process (S26). In other words, the OTA master 30 executes a software update, and then specifies the configuration information used to update the communication settings that are applied after the software update. This allows for proper updating of the communication settings of the vehicle on-board network 10 in correspondence with the software update to the vehicle on-board device 14.

(6) When multiple types of configuration information stored in the memory 21 do not include configuration information that corresponds to the identifier reported from the OTA master 30, the SDN controller 15 acquires the configuration information from the external data center 35. Thus, even if the suitable configuration information is not stored in the memory 21, the communication settings are updated in a suitable manner.

(7) Based on the update data distributed from the data center 35, the OTA master 30 updates multiple types of configuration information stored in the memory 21 of the SDN controller 15. That is, multiple types of configuration information are stored in the memory 21 of the SDN controller 15 in a state in which the OTA master 30 is given permission to update the multiple types of configuration information. As a result, each type of configuration information stored in the memory 21 is updated in correspondence with changes or the like in the functions of the vehicle on-board device 14 due to a software update.

### Modifications

The above-described embodiments may be modified as follows. The above-described embodiments and the following modifications can be combined as long as the combined modifications remain technically consistent with each other. The present disclosure is not limited to these examples and is intended to include all modifications described by the scope of claims and corresponding to equivalents of the scope of claims.

### Update Operation for Software and Configuration Information

The updating of software and the updating of configuration information using the OTA master 30 of the second embodiment may be performed collectively.

The OTA master 30 may be configured to update the software of the vehicle on-board device 14 but not to update the configuration information. In this case, multiple types of configuration information are stored in the memory 21 of the SDN controller 15 in a state in which the OTA master 30 is not given permission to update the multiple types of configuration information.

During a software update, the OTA master 30 replaces the identifier stored in the vehicle on-board device 14 with the identifier reported from the data center 35. After the software update is completed, the SDN controller 15 may obtain the identifier used to update the communication settings from the vehicle on-board device 14 in which the software has been updated.

In step S25 of FIG. 4, the OTA master 30 issues the notification of software update completion and the notification of an identifier. The identifier notification may serve as the notification of the software update completion. In step S25 of this case, only the notification of the identifier from the OTA master 30 to the SDN controller 15 is performed.

The SDN controller 15 may include each vehicle on-board device 14 as a target for updating communication settings.

### Acquisition Process

The SDN controller 15 may acquire the identifier for the configuration information used to update the communication settings from the external data center 35.

### Update Operation for Communication Settings When Configuration Information to Be Selected in Selecting Process Is Not Included in Multiple Types of Configuration Information Stored in Memory 21

When the OTA master 30 is installed in the vehicle on-board network 10, the processes of S12 and S13 in FIG. 3 may be replaced with a process that obtains configuration information from the external data center 35 via the OTA master 30.

The processes of S12 and S13 of FIG. 3 and the processes of S54 and S55 in FIG. 6 may be replaced with a process that obtains configuration information from the external data center 35 via a diagnostic tool that is wired to the vehicle on-board network 10.

The updating operations executed when the configuration information to be selected in the selecting process are not included in multiple types of configuration information stored in the memory 21, that is, the updating processes shown in FIGS. 3 and 6, do not have to be executed. For example, in this case, communication settings may be updated manually.

### Other Modifications

The SDN controller 15 of the second embodiment may be configured not to update communication settings when a new vehicle on-board device 14 is connected.

Some or all of the SDN switches 12 installed in the vehicle on-board network 10 may be replaced with other relay devices that perform frame transfer, such as routers, and allow communication settings to be updated via software.

In the vehicle on-board network 10 of the above-described embodiment, the vehicle on-board device 14 is configured to execute frame-based communication; that is, execute communication at the data link layer (L2). The vehicle on-board network 10 may be configured to conduct communication between vehicle on-board devices 14 at a layer other than the data link layer. That is, the SDN controller 15 of the above-described embodiment may be a device that controls the communication settings of each communication device in a vehicle on-board network that includes multiple communication devices for message-based communication.

The SDN controller 15 may be configured to function as a configuration device that updates the communication settings of multiple communication devices installed in the vehicle on-board network 10. The OTA master 30 may have any configuration including the functions of the management device, which manages the software update to the vehicle on-board devices 14 connected to the vehicle on-board network 10. For example, any of the ECUs may also be configured to function as one or both of the SDN controller 15 and the OTA master 30 in the above-described embodiments. That is, the configuration device may include circuitry including one or more processors that perform various processes according to computer programs (software). The configuration device may be circuitry including one or more exclusive hardware circuits, such as an application-specific integrated circuit (ASIC), to execute at least part of various processes. Alternatively, the configuration device may be circuitry including a combination thereof. The processor includes a CPU and a memory, such as a RAM and a ROM. The memory stores program codes or instructions configured to cause the CPU to execute the processes. The memory, or a computer-readable medium, includes any type of medium that is accessible by general-purpose computers and dedicated computers.

1. A configuration device configured to control communication settings of multiple communication devices of a vehicle on-board network, wherein
the configuration device includes a memory that stores multiple types of configuration information to which unique identifiers are respectively assigned,
the configuration device comprises circuitry configured to execute an acquisition process, a selecting process, and an updating process when connecting a vehicle on-board device to the vehicle on-board network,
the acquisition process is a process that acquires an identifier corresponding to the vehicle on-board device from outside,
the selecting process is a process that selects, from the multiple types of configuration information, configuration information corresponding to the identifier acquired in the acquisition process, and
the updating process is a process that updates the communication settings of the communication devices based on the configuration information selected in the selecting process.

2. The configuration device according to claim 1, wherein
the identifier is acquired from the vehicle on-board device in the acquisition process.

3. The configuration device according to claim 1, wherein
the vehicle on-board network includes a management device that manages an update of software of the vehicle on-board device connected to the vehicle on-board network, and
the circuitry is configured to execute the acquisition process, the selecting process, and the updating process when reconnecting the vehicle on-board device to the vehicle on-board network in which the software has been updated.

4. The configuration device according to claim 3, wherein
the management device notifies the circuitry of the identifier for the vehicle on-board device in which the software has been updated, and
the circuitry is configured to acquire the identifier in the acquisition process during the reconnection through a notification of the identifier by the management device.

5. The configuration device according to claim 3, wherein
the multiple types of configuration information are stored in the memory in a state in which the management device is given permission to update the multiple types of configuration information.

6. The configuration device according to claim 1, wherein the configuration information includes information on quality-of-service settings for communication and information on communication path restriction settings for security.

7. The configuration device according to claim 1, wherein
the circuitry is configured to acquire, from an external data center, configuration information used for updating the communication settings of the communication devices when failing to select the configuration information in the selecting process.

8. The configuration device according to claim 1, wherein
the circuitry is configured to acquire, from the vehicle on-board device, configuration information used for updating the communication settings of the communication devices when failing to select the configuration information in the selecting process.

9. A vehicle on-board device connected to a vehicle on-board network to which communication devices are connected, wherein
the vehicle on-board network includes a configuration device, the configuration device including a memory that stores multiple types of configuration information to which unique identifiers are respectively assigned, and circuitry configured to update communication settings of the communication devices based on the configuration information, and
the vehicle on-board device is configured to notify the circuitry of an identifier for configuration information when connecting to the vehicle on-board network, the configuration information being used by the circuitry to update the communication settings.
